(19) United States
(12) Patent Application Publication
(10) Pub. No.: US 2020/0115933 A1
(43) Pub. Date: Apr. 16, 2020

(54) POWER RELEASE LATCHING SYSTEM

(71) Applicant: Inteva Products, LLC, Troy, MI (US)

(72) Inventors: Daniel Alexander Ney, Lake Orion, MI (US); Donald Michael Perkins, Rochester Hills, MI (US)

(21) Appl. No.: 16/574,982

(22) Filed: Sep. 18, 2019

Related U.S. Application Data
(60) Provisional application No. 62/744,200, filed on Oct. 11, 2018.

(51) Int. Cl. E05B 81/34; E05B 81/06; E05B 81/42; E05B 81/20

(52) U.S. Cl. CPC E05B 81/34; E05B 81/06; E05B 81/42; E05B 81/20; E05Y 2900/531; E05Y 2201/638; E05Y 2201/484; E05Y 2201/434; E05Y 2201/702

(57) ABSTRACT

A power release latching system includes a gear and a pawl release lever. The gear is adapted to rotate about a rotation axis, and includes a serpentine cam component. The pawl release lever is adapted to pivot about a pivot axis spaced from and disposed parallel to the rotation axis. The pawl release lever includes a serpentine cam portion in camming contact with the serpentine cam component. The camming contact is configured to change from a low-speed-high-torque condition to a high-speed-low torque condition as the pawl release lever pivots from a neutral position to an end high position.

### CROSS-REFERENCE TO RELATED APPLICATIONS

This application claims the benefit of 62/744,200 filed Oct. 11, 2018, which is incorporated herein by reference in its entirety.

### BACKGROUND

The subject matter disclosed herein relates to door latches and, more particularly, to power release latching systems.

Traditional vehicle doors often include seals that produce a sealing force exerted upon latching systems. To overcome the sealing force, traditional power release latching systems operate at high-torque and low-speed conditions. Unfortunately, this contributes toward slow release, or opening, of the door. Accordingly, it is desirable to provide an improved power releasing latching system and method of operation.

### BRIEF DESCRIPTION

A power release latching system according to one, non-limiting, embodiment of the present disclosure comprises a gear adapted to rotate about a rotation axis, the gear including a serpentine cam component; and a pawl release lever adapted to pivot about a pivot axis spaced from and disposed parallel to the rotation axis, the pawl release lever include a serpentine cam portion being in camming contact with the serpentine cam component, wherein the camming contact is configured to change from a low-speed-high-torque condition to a high-speed-low torque condition as the pawl release lever pivots from a neutral position to an end high position.

In addition to the foregoing embodiment, the gear includes a first stop surface adapted to contact a stationary structure indexing the gear at the neutral position, and a second stop surface adapted to contact the stationary structure indexing the gear at the end high position.

In the alternative or additionally thereto, in the foregoing embodiment, the power release latching system further comprises a torsional biasing member engaged between the pawl release lever and the stationary structure, the torsional biasing member adapted to exert a torsional force that biases the pawl release lever toward the neutral position and the first stop surface against the stationary structure.

A power release latching system according to another, non-limiting, embodiment comprises a gear adapted to rotate about a rotation axis, the gear including a cam component having an inner protrusion and an outer protrusion located radially outward from the inner protrusion and with respect to the rotation axis; and a pawl release lever adapted to pivot about a pivot axis spaced from and disposed parallel to the rotation axis, the pawl release lever including a cam portion having an inward bulge and an outward bulge located radially outward from the inward bulge and with respect to the rotation axis, wherein the inner and outer protrusions are generally circumferentially opposed to the inward and outward bulges and adapted to initially drive the pawl release lever at a low-speed-high-torque condition then at a high-speed-low-torque condition.

Additionally, to the foregoing embodiment, the cam component and the cam portion are configured to operatively mate as the gear rotates about the rotation axis.

In the alternative or additionally thereto, in the foregoing embodiment, the power release latching further comprises a torsional biasing member engaged between the pawl release lever and a stationary structure to bias the pawl release lever in a pivot direction with respect to the pivot axis that is opposite to a gear drive direction with respect to the rotation axis.

In the alternative or additionally thereto, in the foregoing embodiment, the power release latching system further comprises a worm gear adapted to drive the gear in the gear drive direction; and an electric motor adapted to drive the worm gear.

In the alternative or additionally thereto, in the foregoing embodiment, the cam component includes an inner convex surface carried by the inner protrusion, an outer convex surface carried by the outer protrusion and a concave surface extending between the inner and outer convex surfaces, and the cam portion includes an inward convex face carried by the inward bulge, an outward convex face carried by the outward bulge, and a concave face extending between the inward and outward convex faces.

In the alternative or additionally thereto, in the foregoing embodiment, the cam component is spaced from the cam portion when in a neutral position.

In the alternative or additionally thereto, in the foregoing embodiment, the inner convex surface is adapted to move toward and contact the inward convex face as the gear is driven from a neutral position and to an initially driven low position.

In the alternative or additionally thereto, in the foregoing embodiment, the inner protrusion is located at least in-part between the inward and outward bulges when in a mid low position, and the initially driven low position is located between the mid low position and the neutral position.

In the alternative or additionally thereto, in the foregoing embodiment, the inner convex surface is in contact with at least one of the inward and outward convex faces when in the mid low position.

In the alternative or additionally thereto, in the foregoing embodiment, the inner convex surface is in contact with the inward convex face and the outer convex surface opposes the outward convex face when the in an end low position, and the mid low position is located between the end low position and the initially driven low position.

In the alternative or additionally thereto, in the foregoing embodiment, the inner protrusion contacts the inward bulge and the outer protrusion contacts the outward bulge when in an initially driven high position, and the end low position is located between the initially driven high position and the mid low position.

In the alternative or additionally thereto, in the foregoing embodiment, a contact force vector directed by the outer surface against the outward face is substantially parallel to a contact force vector directed by the inner surface against the inward face when in the initially driven high position.

In the alternative or additionally thereto, in the foregoing embodiment, the inner protrusion is spaced from the inward bulge by a first distance and the outer protrusion is in contact with the outward bulge when in a mid high position, and the initially driven high position is located between the mid high position and the end low position.

In the alternative or additionally thereto, in the foregoing embodiment, the inner protrusion is spaced from the inward bulge by a second distance and the outer protrusion is in contact with the outward bulge when in an end high position, the first distance is less than the second distance, and the mid high position is located between the end high position and the initially driven high position.

In the alternative or additionally thereto, in the foregoing embodiment, the outer protrusion is located at least in-part between the inward and outward bulges, and is in contact with the concave face when in a locked position preventing the torsional biasing member from back-driving the pawl release lever and the gear when not being driven.

In the alternative or additionally thereto, in the foregoing embodiment, the power release latching system further comprises a worm gear adapted to drive the gear in the gear drive direction; and an electric motor adapted to drive the worm gear, wherein the outer protrusion is located at least in-part between the inward and outward bulges, and is in contact with the concave face when in a locked position preventing the torsional biasing member from back-driving the pawl release lever and the gear when not being driven by the electric motor.

In the alternative or additionally thereto, in the foregoing embodiment, a contact force vector exerted by the cam component against the cam portion has a moment arm ratio within a range of 4.9:1 to 7.0:1 when in the mid low position, and the contact force vector has a moment arm ratio within a range of 3.0:1 to 4.9:1 when in the mid high position.

A method of operating a power release latch system according to another, non-limiting, embodiment comprises driving a gear about a rotation axis from a neutral position and toward an end low position while in a low-speed-high-torque condition; pivoting a pawl release lever about a pivot axis via a first cam arrangement carried between the gear and the pawl release lever as the gear rotates from the neutral position to the end low position; releasing a claw from a striker when in about the end low position; driving the gear about the rotation axis from the end low position to an end high position while in a high-speed-low torque condition; and further pivoting the pawl release lever about the pivot axis via a second cam arrangement carried between the gear and the pawl release lever as the gear rotates from the end low position to the end high position.

### BRIEF DESCRIPTION OF THE DRAWINGS

The following descriptions should not be considered limiting in any way. With reference to the accompanying drawings, like elements are numbered alike:

FIG. 1 is a partial plan view and partial schematic of a power release latching system as one non-limiting, exemplary embodiment of the present disclosure illustrated in a neutral position;

FIG. 2 is a partial plan view of the power release latching system taken from circle 2 in FIG. 1;

FIG. 3 is a partial plan view of the power release latching system illustrated in an initially driven low position;

FIG. 4 is a partial plan view of the power release latching system illustrated in a mid low position;

FIG. 5 is a partial plan view of the power release latching system illustrated in an end low position;

FIG. 6 is a partial plan view of the power release latching system illustrated in an initially driven high position;

FIG. 7 is a partial plan view of the power release latching system illustrated in a mid high position;

FIG. 8 is a partial plan view of the power release latching system illustrated in an end high position;

FIG. 9 is a partial plan view of the power release latching system illustrated in a locked position; and

FIG. 10 is a partial plan view of the power release latching system illustrating an opposite side of a gear of the power release latching system to show a stop of the gear.

### DETAILED DESCRIPTION

A detailed description of one or more embodiments of the disclosed apparatus and method are presented herein by way of exemplification and not limitation with reference to the Figures.

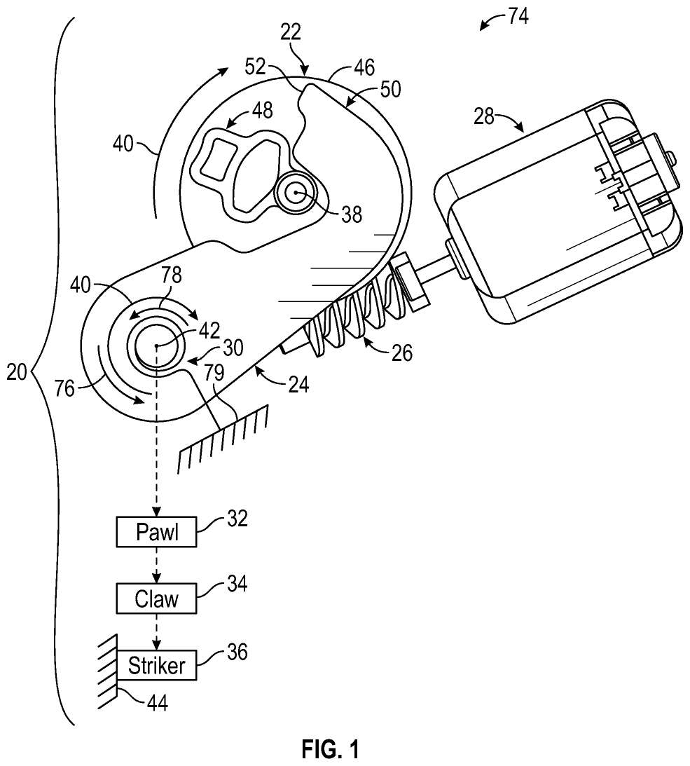

Referring now to FIG. 1, a power release latching system 20 is illustrated, in-part, as a plan view, and illustrated, in-part, as a schematic. The power release latching system 20 may include a gear 22, a pawl release lever 24, a worm gear 26, an electric motor 28, a torsional biasing member 30, a pawl 32, a claw 34, and a striker 36. The electric motor 28 is adapted to drive (i.e., rotate) the worm gear 26, which in-turn drives the gear 22 about a rotation axis 38 and in a rotational driven direction (see arrow 40) with respect to rotation axis 38. Rotation of the gear 22 drives the pawl release lever 24, which pivots about a pivot axis 42 and in the same driven direction 40 (e.g., clockwise as illustrated) but with respect to pivot axis 42. As is generally known by one skilled in the art of latches, the pivoting motion of the pawl release lever 24 in the driven direction 40 may rotate the pawl 32 that actuates the claw 34. Actuation of the claw 34 facilitates release of the claw from the striker 36 that is typically mounted to a stationary structure 44 (e.g., door frame). In one embodiment, the rotation axis 36 and the pivot axis 38 are substantially parallel to, and spaced apart from one-another.

The gear 22 includes a disk component 46 that carries a plurality of gear teeth (not shown) that mate with the worm gear 26 and a cam component 48. The cam component 48 may be rigidly attached to the disk component 46. In one embodiment, the gear 22 may be one unitary piece, and may be made of an injection molded plastic.

In one embodiment, the pawl release lever 24 projects radially outward from the pivot axis 42 and to a segment 50 (e.g., distal end segment) that may be orientated beyond the rotation axis 38. The distal end segment 50 includes a cam portion 52 adapted to operatively contact, or mate with, the cam component 48 of the gear 22. The cam component 48 and the cam portion 52 may generally circumferentially oppose one-another. The cam component 48 generally faces in the driven direction 40 and the cam portion 52 generally faces in a circumferential direction that is opposite the driven direction 40.

The cam component 48 of the gear 22 and the cam portion 52 of the pawl release lever 24 are shaped to promote a low-speed, high-torque, operation of the pawl release lever 24 to initially release the claw 34 from the striker 36. After release, and with continued pivoting of the pawl release lever 24 in the driven direction 40, the motion of the pawl release lever 24 transforms to a high-speed and low-torque condition. In one example, and to facilitate the desired change in operation condition, the cam component 48 and the cam portion 52 may each be serpentine in shape.

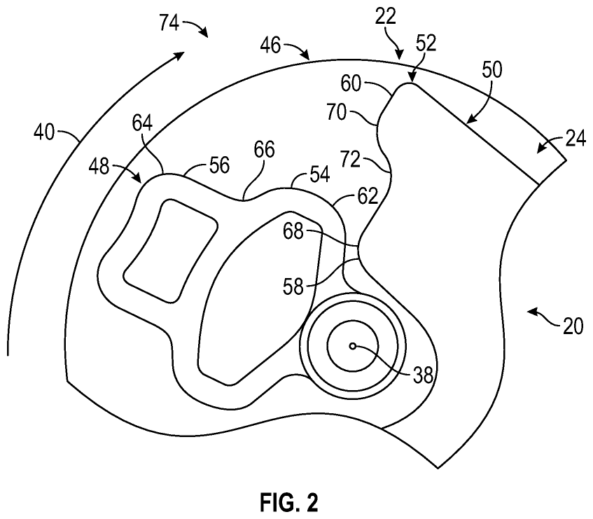

More specifically and referring to FIGS. 1 and 2, the cam component 48 may include an inner protrusion 54 and an outer protrusion 56 located radially outward from the inner protrusion 54, and with respect to the rotation axis 38. The cam portion 52 of the pawl release lever 24 may include an inward bulge 58 and an outward bulge 60 located radially outward from the inward bulge 58, and with respect to the rotation axis 38. The inner and outer protrusions 54, 56 of the cam component 48 are generally circumferentially opposed to the inward and outward bulges 58, 60 of the cam portion 52. The protrusions 54, 56 and the bulges 58, 60 are configured such that the pawl release lever 24 is initially driven at a low-speed-high-torque condition then at a high-speed-low-torque condition.

Referring to FIG. 2, the inner protrusion 54 of the cam component 48 carries an inner convex surface 62, and the outer protrusion 56 of the cam component 48 carries an outer convex surface 64. A concave surface 66 of the cam component 48 faces, at least in part, in the circumferential driven direction 40, and spans between and contiguously forms into the convex surfaces 62, 64.

The inward bulge 58 of the cam portion 52 carries an inward convex face 68, and the outward bulge 60 of the cam portion 52 carries an outward convex face 70. A concave face 72 of the cam portion 52 faces, at least in part, in a circumferential direction that is opposite the driven direction 40, and spans between and contiguously forms into the convex faces 68, 70.

Referring to FIGS. 1 and 2, the cam component 48 is space from the cam portion 52 when in a neutral position 74. The torsional biasing member 30 is adapted to exert a torsional force (see arrow 76, see FIG. 1) in a pivot direction (see arrow 78) that is opposite the driven direction 40 and against the pawl release lever 24. The biasing member 30, thereby facilitates a return of the pawl release lever 24 to the neutral position 74. In one example, the biasing member 30 is a torsion spring, and may have one end engaged to a stationary, or fixed, structure 79 (see FIG. 1) and an opposite end engaged to the pawl release lever 24. It is further contemplated and understood that the biasing member may be located elsewhere, and may directly act upon any component that, in-turn, is capable of exerting the torsion force 76 upon the pawl release lever 24.

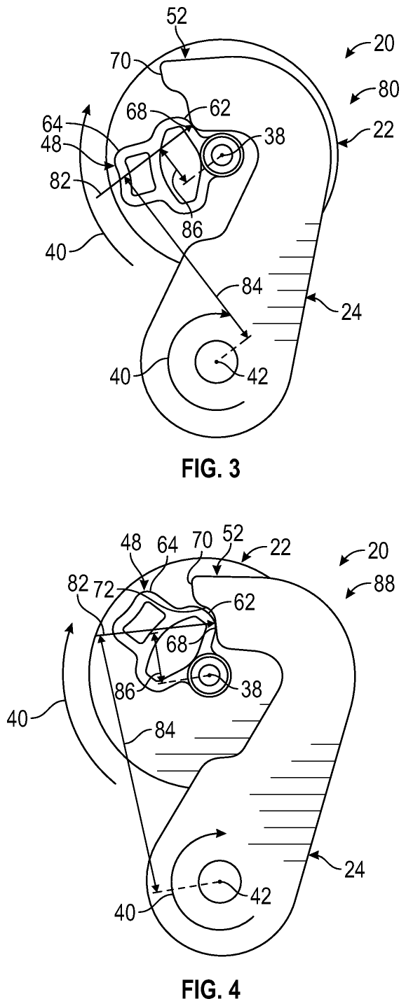

In operation and referring to FIGS. 2 and 3, when power release latching system 20 receives a command to unlatch, the electric motor 28 is energized and rotates the worm gear 26 (see FIG. 1) at a predefined rate. The worm gear 26 rotates the gear 22, which causes the power release latching system 20 to move from the neutral position 74 and into an initially driven low position 80. During this motion, the pawl release lever 24 pivots at a relatively low rotational speed, but with a relatively high torque (i.e., low-speed-high-torque condition). When in the initially driven low position 80, the inner protrusion 54 of the cam component 48 is in contact with the inward bulge 58 of the cam portion 52. Thus, the inner convex surface 62 is in camming contact with the inward convex face 68, while the outer convex surface 64 is spaced from the outward convex face 70.

A contact force vector (see arrow 82) is exerted by the cam component 48 of the gear 22 against the cam portion 52 of the pawl release lever 24 at the point of contact between the inner convex surface 62 and the inward convex face 68. A lever moment arm (see arrow 84) is measured between the pivot axis 42 and the contact force vector 82. A gear moment arm (see arrow 86) is measured between the rotation axis 38 and the contact force vector 82. When in the initially driven low position 80, a moment arm ratio (i.e., lever moment arm 84 over gear moment arm 86) may be relatively high, and may be within a range of about 4.9:1 to 5.7:1, and preferably about 31.0:6.2.

In one embodiment and when in the initially driven low position 80, the gear 22 has rotated about five degrees (5°) from the neutral position 74, and the pawl release lever 24 remains in a home position (i.e., has not yet pivoted).

With continued operation and referring to FIGS. 2 and 4, the power release latching system 20 moves from the initially driven low position 80 and into a mid low position 88 while generally in the low-speed-high-torque condition. When in the mid low position 88, the inner protrusion 54 is located at least in-part between the inward and outward bulges 58, 60. That is, the inner convex surface 62 may still be in contact with the inner convex face 68, but is closer to the concave face 72. The outer convex surface 64 remains spaced from the outward convex face 70. The initially driven low position 80 (see FIG. 3) is located rotationally between the mid low position 88 (see FIG. 4) and the neutral position 74 (see FIG. 2).

When in the mid low position 88, the contact force vector (see arrow 82) is exerted at a point of contact between the inner convex surface 62 and the inward convex face 68. The lever moment arm 84, measured between the pivot axis 42 and the contact force vector 82, and the gear moment arm 86, measured between the rotation axis 38 and the contact force vector 82, has a moment arm ratio that remains relatively high, and may be within a range of about 4.9:1 to 7.0:1, and preferably about 37.2:7.2.

In one embodiment and when in the mid low position 88 (see FIG. 4), the gear 22 has rotated about sixty-five degrees (65°) from the neutral position 74, and the pawl release lever 24 has pivoted about fifteen degrees (15°) from the neutral position 74.

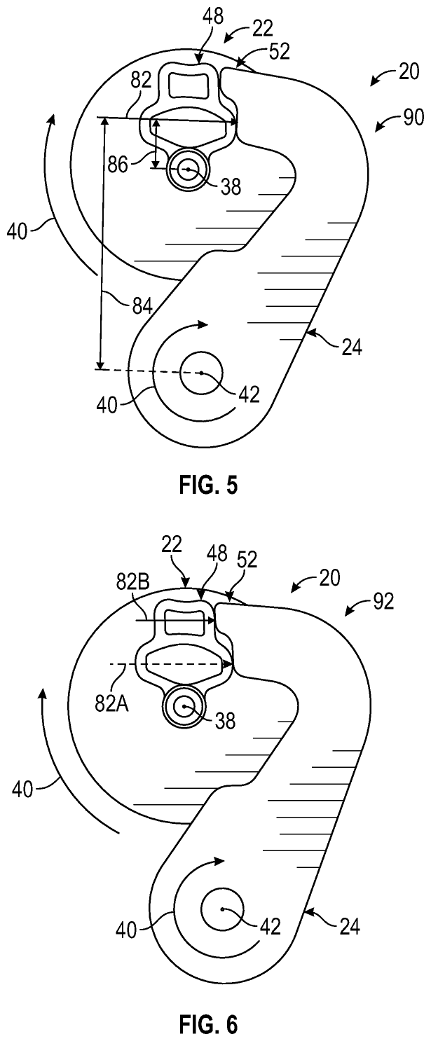

With continued operation and referring to FIGS. 2 and 5, the power release latching system 20 moves from the mid low position 88 and into an end low position 90 while generally in the low-speed-high-torque condition. When in the end low position 90, the inner protrusion 54 is located at least in-part between the inward and outward bulges 58, 60. That is, the inner convex surface 62 may still be in contact with the inner convex face 68, and is close to the concave face 72. The outer convex surface 64 is spaced from, and directly opposes, the outward convex face 70, but is considerably closer than when in the mid low position 88. The mid low position 88 (see FIG. 4) is located rotationally between the end low position 90 and the initially driven low position 80 (see FIG. 3).

When in the end low position 90, the contact force vector 82 is exerted at a point of contact between the inner convex surface 62 and the inward convex face 68. The moment arm ratio of the lever moment arm 84 over the gear moment arm 86 remains relatively high, and may be within a range of about 4.9:1 to 5.7:1, and preferably about 36.2:6.6.

In one embodiment and when in the end low position 90 (see FIG. 5), the gear 22 has rotated about one hundred and ten degrees (110°) from the neutral position 74, and the pawl release lever 24 has pivoted about twenty degrees (20°) from the neutral position 74.

With continued operation and referring to FIGS. 2 and 6, the power release latching system 20 moves from the end low position 90 and into an initially driven high position 92 generally denoting a transition from the low-speed-high-torque condition and into a high-speed-low-torque condition. When in the initially driven high position 92, the inner protrusion 62 contacts the inward bulge 68 (i.e., and/or may be initially separating therefrom), and the outer protrusion 56 contacts the outward bulge 60. That is, the inner convex surface 62 may still be in contact with the inner convex face 68 near the concave face 72, and the outer convex surface 64 near the concave surface 66 is in contact with the outward convex face 70. The end low position 90 (see FIG. 5) is located rotationally between the initially driven high position 92 and the mid low position 88 (see FIG. 4).

When in the initially driven high position 92, the contact force vector 82 may be distributed between the inward and outward bulges 58, 60, respectively, as vectors 82A, 82B. The vectors 82A, 82B may be substantially parallel to one another.

In one embodiment and when in the initially driven high position 92 (see FIG. 6), the gear 22 has rotated about one hundred and fifteen (115°) from the neutral position 74, and the pawl release lever 24 has pivoted about twenty and a half degrees (20.5°) from the neutral position 74.

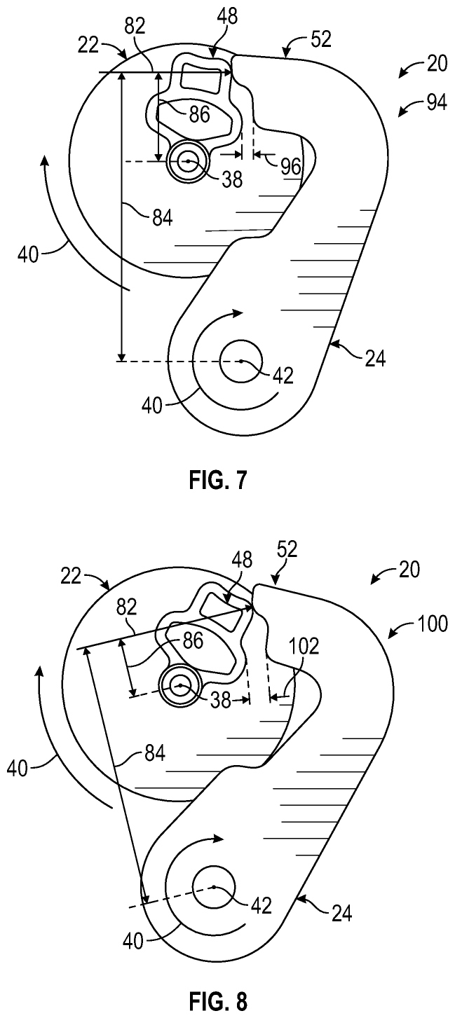

With continued operation and referring to FIGS. 2 and 7, the power release latching system 20 moves from the initially driven high position 92 and into a mid high position 94 while remaining in the high-speed-low-torque condition. When in the mid high position 94, the inner protrusion 54 is spaced from the inward bulge 58 by a distance (see arrow 96), and the outer protrusion 56 is in contact with the outward bulge 52. That is, the outer convex surface 64 is in contact with the outward convex face 70. The initially driven high position 92 (see FIG. 6) is located rotationally between the mid high position 94 and the end low position 90 (see FIG. 5).

When in the mid high position 94, the contact force vector 82 is exerted at a point of contact between the outer convex surface 64 and the outward convex face 70. The moment arm ratio of the lever moment arm 84 over the gear moment arm 86 is relatively low, and may be within a range of about 3.0:1 to 4.9:1, and preferably about 42.0:12.7.

In one embodiment and when in the mid high position 94 (see FIG. 7), the gear 22 has rotated about one hundred and thirty degrees (130°) from the neutral position 74, and the pawl release lever 24 has pivoted about twenty-five degrees (25°) from the neutral position 74.

With continued operation and referring to FIGS. 2 and 8, the power release latching system 20 moves from the mid high position 94 and into an end high position 100 while remaining in the high-speed-low-torque condition. When in the end high position 100, the inner protrusion 54 is spaced from the inward bulge 58 by a distance (see arrow 102), and the outer protrusion 56 is in contact with the outward bulge 52. That is, the outer convex surface 64 is in contact with the outward convex face 70. In one embodiment, the distance 96 when in the mid high position 94 (see FIG. 7) is less than the distance 102 when in the end high position 100. The mid high position 94 (see FIG. 7) is located rotationally between the end high position 100 and the initially driven high position 92 (see FIG. 6).

When in the end high position 100, the contact force vector 82 is exerted at a point of contact between the outer convex surface 64 and the outward convex face 70. The moment arm ratio of the lever moment arm 84 over the gear moment arm 86 is relatively low, and may be within a range of about 3.0:1 to 4.9:1, and preferably about 37.5:7.8.

In one example and after the power release latching system 20 has reached the end high position 100, the electric motor 28 may be de-energized. Without the worm gear 26 driving the gear 22, the force 76 exerted by the torsional biasing member 30 may overcome and back-drive the system 20 in the pivot direction 78 (see FIG. 1) opposite the driven direction 40.

In one embodiment and when in the end high position 100 (see FIG. 8), the gear 22 has rotated about one hundred and forty-five degrees (145°) from the neutral position 74, and the pawl release lever 24 has pivoted about thirty degrees (30°) from the neutral position 74.

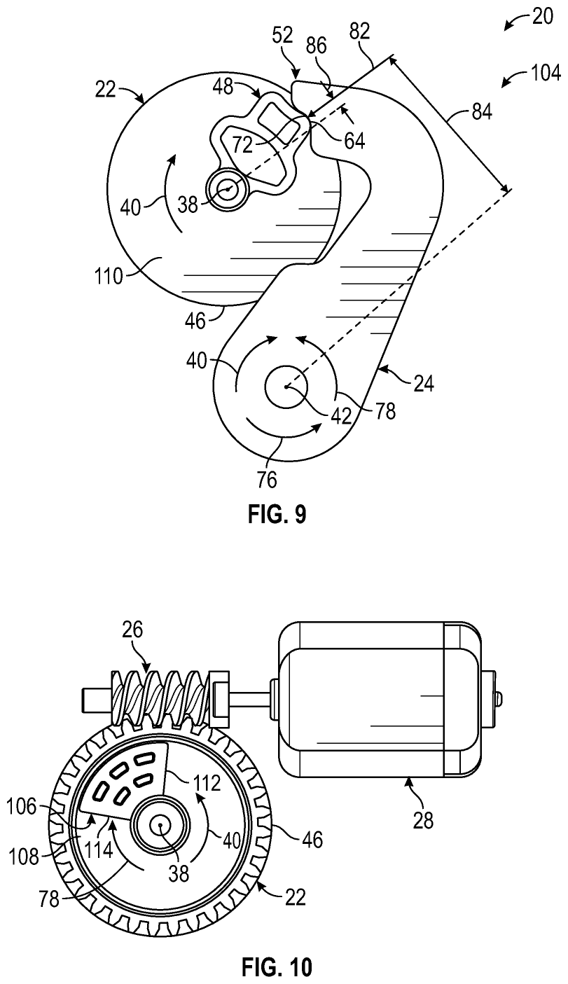

Referring to FIGS. 2 and 9, the gear 22 of the power release latching system 20 may be adapted to be further driven in the direction 40, and about rotation axis 38, from the end high position 100 and into a locked position 104 while in the high-speed-low-torque condition. When in the locked position 104, the outer protrusion 56 is located, at least in-part, between the inward and outward bulges 58, 60, and is in contact with the concave face 72. This orientation of the locked position 104 prevents the torsional biasing member 30 from back-driving the pawl release lever 24 and the gear 22 when not being driven by the electric motor 28.

When in the locked position 104, the contact force vector 82 is exerted at a point of contact between the outer convex surface 64 and the concave face 72. The moment arm ratio of the lever moment arm 84 over the gear moment arm 86 is high, and may be within a range of about 18:1 to 19:1, and preferably about 29.7:1.6.

In one embodiment and when in the locked position 104 (see FIG. 9), the gear 22 has rotated about one hundred and fifty-five degrees (155°) from the neutral position 74, and the pawl release lever 24 has return pivoted in the pivot direction 78 by about one degree (1°). This return pivot is facilitated by the torsional force 76 of the torsional biasing member 30. That is, when in the end high position 100 the pawl release lever 24 is about thirty degrees (30°) from the neutral position 74, and when in the locked position 104 the pawl release lever 24 is about twenty-nine degrees (29°) from the neutral position 74.

Referring to FIG. 10, the gear 22 may further include at least one stop 106 adapted to index the gear 22 at the neutral position 74 (see FIG. 1) and at the end high position 100 (see FIG. 8) if the embodiment does not include the locked position 104 (see FIG. 9). The stop 106 may project axially outward from a first side 108 of the gear component 46, and the cam component 48 may project axially outward from an opposite side 110 of the cam component 48 (see FIG. 9).

The stop 106 may include circumferentially opposing stop surfaces 112, 114 each adapted to contact a stationary structure (e.g., housing). Contact of stop surface 112 is orientated to stop rotation of the gear 22 in the rotation direction 78 about axis 38, thus designating the neutral position 74 (see FIG. 1). Stop surface 114 is orientated to stop rotation of the gear 22 in the rotation direction 40, thus designating the end high position 100 (see FIG. 8), or if the feature exists—the locked position 104 (see FIG. 9).

During operation, the power release latching system 20 facilitates an initial, high torque, output to release a latch that may be under a large seal load. The high torque output continues until the seal load is relieved, then the system 20 operates at a low torque output to complete a remaining amount of travel. This is achieved by using a high torque ratio through first part of travel of the gear 22 of the system 20. A first cam relationship between the gear 22 and the pawl release lever 24 drives at a high force vector on the pawl release lever 24 until the claw 34 is released, then a second cam relationship is applied to provide a greater angular rotation speed to the pawl release lever, without requiring an increase in gear speed rotation. By using this technique, the system 20 is able to release high seal loads while the pawl 32 and claw 34 are in contact, and use of a smaller gear than traditional gears is enabled. Use of a smaller gear 22 assists in faster release times.

Advantages and benefits of the present disclosure include a power release latching system 20 capable of releasing with large seal loads applied to the system while achieving the required travel, and doing so efficiently and quickly.

The term “about” is intended to include the degree of error associated with measurement of the particular quantity based upon the equipment available at the time of filing the present disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A power release latching system comprising:
a gear adapted to rotate about a rotation axis, the gear including a serpentine cam component; and
a pawl release lever adapted to pivot about a pivot axis spaced from and disposed parallel to the rotation axis, the pawl release lever include a serpentine cam portion being in camming contact with the serpentine cam component, wherein the camming contact is configured to change from a low-speed-high-torque condition to a high-speed-low torque condition as the pawl release lever pivots from a neutral position to an end high position.

2. The power release latching system set forth in claim 1, wherein the gear includes a first stop surface adapted to contact a stationary structure indexing the gear at the neutral position, and a second stop surface adapted to contact the stationary structure indexing the gear at the end high position.

3. The power release latching system set forth in claim 2, further comprising:
a torsional biasing member engaged between the pawl release lever and the stationary structure, the torsional biasing member adapted to exert a torsional force that biases the pawl release lever toward the neutral position and the first stop surface against the stationary structure.

4. A power release latching system comprising:
a gear adapted to rotate about a rotation axis, the gear including a cam component having an inner protrusion and an outer protrusion located radially outward from the inner protrusion and with respect to the rotation axis; and
a pawl release lever adapted to pivot about a pivot axis spaced from and disposed parallel to the rotation axis, the pawl release lever including a cam portion having an inward bulge and an outward bulge located radially outward from the inward bulge and with respect to the rotation axis, wherein the inner and outer protrusions are generally circumferentially opposed to the inward and outward bulges and adapted to initially drive the pawl release lever at a low-speed-high-torque condition then at a high-speed-low-torque condition.

5. The power release latching system set forth in claim 4, wherein the cam component and the cam portion are configured to operatively mate as the gear rotates about the rotation axis.

6. The power release latching system set forth in claim 5, further comprising:
a torsional biasing member engaged between the pawl release lever and a stationary structure to bias the pawl release lever in a pivot direction with respect to the pivot axis that is opposite to a gear drive direction with respect to the rotation axis.

7. The power release latching system set forth in claim 6, further comprising:
a worm gear adapted to drive the gear in the gear drive direction; and
an electric motor adapted to drive the worm gear.

8. The power release latching system set forth in claim 6, wherein the cam component includes an inner convex surface carried by the inner protrusion, an outer convex surface carried by the outer protrusion and a concave surface extending between the inner and outer convex surfaces, and the cam portion includes an inward convex face carried by the inward bulge, an outward convex face carried by the outward bulge, and a concave face extending between the inward and outward convex faces.

9. The power release latching system set forth in claim 8, wherein the cam component is spaced from the cam portion when in a neutral position.

10. The power release latching system set forth in claim 8, wherein the inner convex surface is adapted to move toward and contact the inward convex face as the gear is driven from a neutral position and to an initially driven low position.

11. The power release latching system set forth in claim 10, wherein the inner protrusion is located at least in-part between the inward and outward bulges when in a mid low position, and the initially driven low position is located between the mid low position and the neutral position.

12. The power release latching system set forth in claim 11, wherein the inner convex surface is in contact with at least one of the inward and outward convex faces when in the mid low position.

13. The power release latching system set forth in claim 11, wherein the inner convex surface is in contact with the inward convex face and the outer convex surface opposes the outward convex face when the in an end low position, and the mid low position is located between the end low position and the initially driven low position.

14. The power release latching system set forth in claim 13, wherein the inner protrusion contacts the inward bulge and the outer protrusion contacts the outward bulge when in an initially driven high position, and the end low position is located between the initially driven high position and the mid low position.

15. The power release latching system set forth in claim 14, wherein a contact force vector directed by the outer surface against the outward face is substantially parallel to a contact force vector directed by the inner surface against the inward face when in the initially driven high position.

16. The power release latching system set forth in claim 14, wherein the inner protrusion is spaced from the inward bulge by a first distance and the outer protrusion is in contact with the outward bulge when in a mid high position, and the initially driven high position is located between the mid high position and the end low position.

17. The power release latching system set forth in claim 16, wherein the inner protrusion is spaced from the inward bulge by a second distance and the outer protrusion is in contact with the outward bulge when in an end high position, the first distance is less than the second distance, and the mid high position is located between the end high position and the initially driven high position.

18. The power release latching system set forth in claim 17, wherein the outer protrusion is located at least in-part between the inward and outward bulges, and is in contact with the concave face when in a locked position preventing the torsional biasing member from back-driving the pawl release lever and the gear when not being driven.

19. The power release latching system set forth in claim 8, further comprising:
a worm gear adapted to drive the gear in the gear drive direction; and
an electric motor adapted to drive the worm gear, wherein the outer protrusion is located at least in-part between the inward and outward bulges, and is in contact with the concave face when in a locked position preventing the torsional biasing member from back-driving the pawl release lever and the gear when not being driven by the electric motor.

20. The power release latching system set forth in claim 16, wherein a contact force vector exerted by the cam component against the cam portion has a moment arm ratio within a range of 4.9:1 to 7.0:1 when in the mid low position, and the contact force vector has a moment arm ratio within a range of 3.0:1 to 4.9:1 when in the mid high position.

21. A method of operating a power release latch system comprising:
driving a gear about a rotation axis from a neutral position and toward an end low position while in a low-speed-high-torque condition;
pivoting a pawl release lever about a pivot axis via a first cam arrangement carried between the gear and the pawl release lever as the gear rotates from the neutral position to the end low position;
releasing a claw from a striker when in about the end low position;
driving the gear about the rotation axis from the end low position to an end high position while in a high-speed-low torque condition; and
further pivoting the pawl release lever about the pivot axis via a second cam arrangement carried between the gear and the pawl release lever as the gear rotates from the end low position to the end high position.
